(19) United States
(12) Patent Application Publication
(10) Pub. No.: US 2026/0355726 A1
(43) Pub. Date: Nov. 12, 2026

(54) ENHANCED HYDROTHERMAL STABILITY OF ZEOLITES FOR SELECTIVE CATALYTIC REDUCTION APPLICATIONS

(71) Applicant: BASF Mobile Emissions Catalysts LLC, lselin, NJ (US)

(72) Inventors: Qi FU, Iselin, NJ (US); Joseph C. DELLAMORTE, Wyandotte, MI (US); Dieter G. VON DEAK, Iselin, NJ (US); Barbara K. SLAWSKI, Iselin, NJ (US); Michael J. BREEN, Iselin, NJ (US); Eduard KUNKES, Ludwigshafen am Rhein (DE); Mukta RAI, Iselin, NJ (US); Vivek VATTIPALLI, Iselin, NJ (US); Ahmad MOINI, Iselin, NJ (US)

(21) Appl. No.: 19/125,981

(22) PCT Filed: Nov. 2, 2023
(86) PCT No.: PCT/EP2023/080592

§ 371 Date: Apr. 30, 2025

(30) Foreign Application Priority Data
Nov. 3, 2022 (EP) 22205420.7

(51) Int. Cl. B01J 29/76; B01D 53/94; B01J 35/61; B01J 37/02; B01J 37/08; C01B 39/48

(52) U.S. Cl. CPC B01J 29/763; B01D 53/9418; B01J 35/615; B01J 35/617; B01J 35/618; B01J 37/0215; B01J 37/0236; B01J 37/08; C01B 39/48; B01D 2255/20761; B01D 2255/50; B01D 2257/404; B01J 2229/186; C01P 2002/72; C01P 2006/12

(57) ABSTRACT

Procedures for forming chabazite zeolites with an intermediate mordenite phase, resulting in zeolites with enhanced hydrothermal stability, methods of preparing the same, zeolites with enhanced hydrothermal stability, catalytic articles containing zeolites with enhanced hydrothermal stability, and methods of reducing nitrogen oxides (NOx) using the same.

The present disclosure is directed to procedures for preparing chabazite zeolites from conventional, zeolite or non-zeolitic alumina and silica sources that lead to zeolites with enhanced hydrothermal stability and improved selective catalytic reduction (SCR) performance. In the procedures of the present disclosure, mordenite (MOR) is observed as an intermediate phase.

Zeolites are aluminosilicate crystalline materials having substantially uniform and ordered pore sizes which, depending upon the type of zeolite and the type and amount of cations included in the zeolite lattice, typically range from about 3 Angstroms to about 10 Angstroms in diameter. Both synthetic and natural zeolites and their use in promoting certain reactions are well known in the art. For example, metal-promoted zeolites, such as copper exchanged zeolites, are used to promote the reaction of ammonia (or an ammonia precursor, such as urea) with nitrogen oxides (NOₓ) in the presence of oxygen to form nitrogen and H₂O, selectively over the competing reaction of oxygen. The catalyzed reaction is therefore generally referred to as selective catalytic reduction (SCR), in which a high degree of nitrogen oxide removal can be achieved using a small amount of a reducing agent.

One particular zeolite that has found use as a catalyst is chabazite (CHA). Methods for its preparation are known in the art. For example, U.S. Pat. No. 4,544,538 to Zones discloses the synthetic preparation of a high silica form (Si/Al ratio of ~15-30) of chabazite known as SSZ-13. It is prepared using an organically templated (N,N,N-trimethyl-1-adamantammonium) hydrothermal synthesis at high temperature (about 150 °C) and autogenous pressure.

Conventional zeolite synthesis methodologies rely on the use of non-zeolitic alumina sources for the synthesis of the target zeolite product. On the other hand, inter-zeolite conversion requires the use of zeolites (e.g., FAU, LTA, etc.) as a source of alumina to synthesize the target zeolite product. The zeolite synthesis pathway may affect the resulting zeolite's structure, stability, and/or activity. For example, the distribution of aluminum (Al) atoms in a zeolite framework may affect the zeolite's hydrothermal stability and/or catalytic activity. Hydrothermal stability generally increases with decreasing framework alumina content (i.e., increasing the silica to alumina ratio (SAR)), but the latter also limits the amount of catalytically active Cu and Fe sites.

Light duty diesel (LDD) applications, where SCR catalysts are often exposed to high temperature hydrothermal conditions, e.g., associated with soot filter regeneration, place particular demand on the hydrothermal stability of the zeolite. It has been found that under harsh hydrothermal conditions, the activity of copper (Cu) or iron (Fe) exchanged SCR chabazite (CHA) begins to decline. Lowering SAR frameworks can increase the amount of catalytically active Cu/Fe sites. Thus, enhancement in hydrothermal stability of lower SAR frameworks would present an effective strategy for LDD performance improvement.

US 2021/171357 A1 relates to a method of synthesizing a zeolite having a chabazite (CHA) crystalline framework, comprising the steps of forming a reaction mixture comprising at least one alumina source comprising a zeolite, at least one silica source, and at least one organic structure directing agent, the reaction mixture having a combined molar ratio of M/Si+R/Si higher than the molar ratio OH⁻/Si, wherein M is moles of alkali metal and R is moles of organic structure directing agent; and crystallizing the reaction mixture to form a product zeolite having the CHA crystalline framework, wherein the product zeolite has a mesopore surface area (MSA) of less than about 25 m²/g.

L. Xie et al., “Excellent Performance of One-Pot Synthesized Cu-SSZ-13 Catalyst for the Selective Catalytic Reduction of NOx with NH₃”, ENVIRONMENTAL SCIENCE & TECHNOLOGY, vol. 48, no. 1, Jan. 7, 2014, pages 566 to 572, relates to Cu-SSZ-13 samples prepared by a one-pot synthesis method.

Accordingly, there is a need for novel zeolites with altered aluminum distributions and/or altered defect densities, such as lower silanol density, as well as novel methods of producing the same, while maintaining hydrothermal stability, such as for LDD SCR applications.

The present disclosure is directed to methods of producing zeolites having a CHA crystalline framework that minimizes structural defect density of the CHA zeolites, which in turn enhances hydrothermal stability and catalytic performance of the product zeolite. Also provided is use of the zeolites to prepare catalytic articles. Such catalytic articles find utility in the treatment of exhaust gas streams, such as those emanating from gasoline or diesel engines. Applicants have found that catalytic articles made by the processes disclosed herein exhibit excellent hydrothermal stability and high catalytic activity over a wide temperature range.

In the process of the present disclosure, an intermediate MOR zeolite phase is formed using different (zeolitic/non-zeolitic) alumina sources. The CHA zeolites of the present disclosure, synthesized from a MOR intermediate phase, appear to be more durable and exhibit improved SCR catalytic activity compared to zeolites prepared using procedures where an MOR intermediate phase does not form.

Applicants surprisingly found that by changing crystallization gel composition and procedure, starting reagent Zeolite Y (Faujasite) can be converted to a mordenite (MOR) phase before a CHA phase is formed and the resultant CHA zeolite has better hydrothermal stability and enhanced LDD performance, such as improved SCR activity after hydrothermal aging, compared to CHA zeolites formed using conventional procedures.

### BRIEF DESCRIPTION OF THE FIGURES

In order to provide an understanding of the embodiments of the present disclosure, reference is made to the appended figures. The figures are exemplary and should not be construed as limiting the disclosure.

FIG. 1 is diagram showing the crystalline phase transitions of chabazite (CHA) prepared by conventional procedures and CHA produced by embodiments of the present disclosure, where an intermediate mordenite (MOR) phase formed.

FIG. 2 is a graph showing the sonic velocity profile during the crystalline process of Exemplary Zeolites 3 and 4 of the present disclosure.

FIG. 3 is a graph showing the X-Ray Diffraction (XRD) profile of Exemplary Zeolite 4, taken at 66 hours, and containing 23% MOR.

FIG. 4 is a graph showing the MOR percentage of Exemplary Zeolite 4 taken at 64-88 hours.

FIG. 5 is a graph showing the X-Ray Diffraction (XRD) profile of Exemplary Zeolite 4, taken at 64-88 hours.

FIG. 6 is a graph showing the particle size distribution (PSD) of Exemplary Zeolite 4, taken at 64-88 hours.

FIG. 7 is a graph showing the selective catalyst reduction (SCR) performance of catalysts derived from embodiments of the present disclosure (Comparative Zeolites 1 and 2 and Exemplary Zeolites 3 and 4).

FIG. 8 is a graph showing the selective catalyst reduction (SCR) performance of catalysts derived from embodiments of the present disclosure (Comparative Zeolite 1 and Exemplary Zeolites 6 and 7).

The present disclosure will now be described more fully. However, the disclosure may be embodied in many different forms and should not be construed as limited to the embodiments set forth herein.

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, “about” refers to small fluctuations. For example, the term “about” can refer to less than or equal to ±5%, such as less than or equal to ±22%, less than or equal to ±1%, less than or equal to ±0.5%, less than or equal to ±0.2%, less than or equal to ±0.1%, or less than or equal to ±0.05%. A value modified by the term “about” also includes the specific value. For instance, “about 5.0” includes 5.0.

As used herein, the term “material” refers to an element, constituent, or substance of which something is composed or can be made.

As used herein, the term “substantially” refers to a property having a statistical occurrence greater than about 75%, for example, greater than about 90%.

As used herein, the term “calcination” refers to heating a solid to an elevated temperature (i.e., above-ambient temperature) in air or oxygen, such as, e.g., to remove impurities or volatile substances from the solid.

As used herein, the term “alumina source” refers to a material comprising aluminum and/or aluminum ions, such as, e.g., aluminum salts, aluminum isopropoxide, and/or aluminum hydroxide.

As used herein, the term “catalyst” or “catalyst composition” refers to a molecule or a material that promotes a reaction.

As used herein, the term “copper source” refers to a material comprising copper and/or copper ions, such as, e.g., a copper salt and/or a copper complex, such as, e.g., copper-tetraethylenepentamine.

As used herein, the term “ion exchange treatment” refers to a process by which one or more ions are incorporated into and/or removed from a zeolite. As a non-limiting example, a zeolite may be subjected to a copper ion-exchange treatment by, e.g., mixing the zeolite with a material comprising copper such as, e.g., CuO, and a solution, such as, e.g., an aqueous zirconium acetate solution.

Claims or descriptions that include “or” or “and/or” between at least one member of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all the group members are present in, employed in, or otherwise relevant to a given product or process.

As used herein, the term “organic structure directing agent” (OSDA) refers to an organic compound capable of affecting the morphology and/or structure of a zeolite. For example, an OSDA may be an ionic organic molecule capable of being incorporated into the zeolite's structure. An OSDA may, e.g., comprise a large and/or sterically bulky organic group. An OSDA may, e.g., comprise an adamantammonium group. Trimethyl adamantammonium is a non-limiting example of an OSDA.

As used herein, the term “reductant” or “reducing agent” refers to a molecule or a material capable of reducing NOₓ at an elevated (i.e., above-ambient) temperature. In some embodiments, the reducing agent is ammonia. In some embodiments, the reducing agent is an ammonia precursor, e.g., urea, and the reductant is a nitrogen reductant. In some embodiments, the reductant includes fuel. In some embodiments, the reductant includes diesel fuel and fractions thereof as well any hydrocarbon and oxygenated hydrocarbons collectively referred to as an HC reductant.

As used herein, the term “selective catalytic reduction” (SCR) refers to a catalytic process of reducing nitrogen oxides (NOₓ) using a reducing agent.

As used herein, the term “silica source” refers to a material comprising silicon and/or silicon oxides, such as, e.g., colloidal silica, silicates, sodium silicate, and/or Ludox AS-40.

As used herein, the term “zeolite” refers to an aluminosilicate material possessing a framework structure consisting of substantially regular porous structure. In some embodiments of the present disclosure, the zeolites include at least two different types of framework structures. In some embodiments of the present disclosure, the zeolites include substantially one framework structure. In some embodiments, zeolites having substantially one framework structure are referred to as “phase pure” zeolites. In some embodiments, non-framework cations balancing the charge of the anionic framework are loosely associated with the framework oxygens, and the remaining pore volume is filled with water molecules. In some embodiments, the non-framework cations are exchangeable. In some embodiments, the water molecules are removable.

The structures of zeolites of the present disclosure may be analyzed using routine techniques in the art, such as, e.g., x-ray diffraction (XRD) and N₂-physisorption. As a non-limiting example, the degree of crystallinity of a zeolite of the present disclosure may be determined by XRD analysis.

The catalytic articles of the present disclosure find utility in the treatment of exhaust gas streams, such as those emanating from diesel engines. In use, an exhaust gas stream is contacted with a catalytic article prepared in accordance with embodiments of the present disclosure.

As discussed below, the catalytic articles have excellent NOₓ reduction activity over a wide range of operative temperatures. As such, the catalytic articles are useful as SCR catalysts.

The term “SCR catalyst” is used herein in a broad sense to mean a selective catalytic reduction in which a catalyzed reaction of nitrogen oxides with a reductant occurs to reduce the nitrogen oxides.

The present disclosure outlines approaches for CHA synthesis from conventional, non-zeolitic or zeolitic alumina and silica sources, that lead to products with improved light duty diesel (LDD) performance.

In some embodiments, there is provided a method of preparing a CHA zeolite having an intermediate labile MOR phase. In some embodiments, the method comprises a step of (a) preparing an aqueous mixture comprising a silica source, an alumina source, a mineralizing agent-usually a strong alkali or organic base, and an organic structure directing agent (OSDA) to form an aqueous gel. In some embodiments, the method further comprises a step of (b) heating the gel at about 100 °C to about 200 °C from about 15 hours to about 90 hours, from about 16 hours to about 80 hours, from about 20 hours to about 70 hours, from about 25 hours to about 60, from about 28 hours to about 50 hours, or from about 30 hours to about 40 hours to form an intermediate phase comprising mordenite (MOR) crystals. In some embodiments, the gel is heated at autogenous pressure corresponding to the vapor pressure of water. In some embodiments, the method further comprises a step of (c) heating the intermediate phase at about 100 °C to about 200 °C from about 15 hours to about 90 hours, from about 16 hours to about 80 hours, from about 20 hours to about 70 hours, from about 25 hours to about 60, from about 28 hours to about 50 hours, or from about 30 hours to about 40 hours to obtain a phase pure CHA zeolite. In some embodiments, the intermediate phase is heated at autogenous pressure corresponding to the vapor pressure of water.

In some embodiments, the silica source is chosen from colloidal silica, precipitated silica, fumed silica, sodium silicate, zeolitic silica, and combinations thereof. In some embodiments, the silica source is colloidal silica. In some embodiments, the silica source is precipitated silica. In some embodiments, the silica source is fumed silica. In some embodiments, the silica source is zeolitic silica. In some embodiments, the silica source is sodium silicate. In some embodiments of the method, the silica source comprises a SiO₂/Na₂O wt % ratio of about 1 to about 4. In some embodiments, the silica source comprises a SiO₂/Na₂O wt % ratio of about 1. In some embodiments, the silica source comprises a SiO₂/Na₂O wt % ratio of about 2. In some embodiments, the silica source comprises a SiO₂/Na₂O wt % ratio of about 3. In some embodiments, the silica source comprises a SiO₂/Na₂O wt % ratio of about 3.3. In some embodiments, the silica source comprises a SiO₂/Na₂O wt % ratio of about 4.0. In some embodiments, the silica source has a solids content of greater than about 20 wt %. In some embodiments, the silica source has a solids content of greater than about 25 wt %. In some embodiments, the silica source has a solids content of greater than about 30 wt %. In some embodiments, the silica source has a solids content of greater than about 35 wt %. In some embodiments, the silica source has a solids content of about 37 wt %. In some embodiments, the mole ratio of silica to alumina (SAR) in the gel is at least about 30. In some embodiments, the mole ratio of silica to alumina (SAR) in the gel is at least about 35.

In some embodiments, the alumina source is chosen from aluminum isopropoxide, aluminum sulfate, zeolitic alumina, aluminum oxides, aluminum hydroxides, and combinations thereof. In some embodiments, the alumina source is aluminum isopropoxide. In some embodiments, the alumina source is aluminum sulfate. In some embodiments, the alumina source is a combination of aluminum isopropoxide and aluminum sulfate. In some embodiments, the alumina source is zeolitic alumina. In some embodiments, the alumina source is an aluminum oxide. In some embodiments, the alumina source is an aluminum hydroxide.

In some embodiments, the method further comprises adding a zeolite initiator. In some embodiments the zeolite initiator is referred to as NaY seeds. In some embodiments, the zeolite initiator is referred to as FAU seeds. In some embodiments, the zeolite initiator comprises a mixture of sodium aluminate, sodium silicate and sodium hydroxide. In some embodiments, the zeolite initiator has a SiO₂/Al₂O₃ molar ratio of about 65. In some embodiment, the zeolite initiator has a SiO₂/Na₂O molar ratio of about 1.7. In some embodiments, the zeolite initiator has an H₂O/SiO₂ molar ratio of about 10.3. In some embodiments, the aqueous gel of step (a) further comprises a zeolite initiator, with a SiO₂/Al₂O₃ molar ratio of about 65, a SiO₂/Na₂O molar ratio of about 1.7, and an H₂O/SiO₂ molar ratio of about 10.3.

In some embodiments, the mineralizing agent is chosen from compounds containing F⁻ (fluoride) and/or OH⁻ (hydroxide) ions. In some embodiments, the mineralizing agent is chosen from alkali hydroxides and fluorides. In some embodiments, the mineralizing agent is chosen from alkali hydroxide. In some embodiments, the mineralizing agent is chosen from fluorides. In some embodiments, the mineralizing agent is NaOH. In some embodiments, the mineralizing agent is KOH. In some embodiments, the mineralizing agent is F⁻ ions. In some embodiments, the mineralizing agent is quaternary ammonium hydroxide. In some embodiments, the mineralizing agent is a combination of NaOH and KOH. In some embodiments, the mineralizing agent is a combination of NaOH and F⁻ ions. In some embodiments, the mineralizing agent is a combination of NaOH and quaternary ammonium hydroxide. In some embodiments, the mineralizing agent is a combination of KOH and F⁻ ions. In some embodiments, the mineralizing agent is a combination of KOH and quaternary ammonium hydroxide. In some embodiments, the mineralizing agent is a combination of F⁻ ions and quaternary ammonium hydroxide.

In some embodiments, the OSDA is chosen from quaternary ammonium salts. In some embodiments, the OSDA is trimethyl adamantyl ammonium hydroxide. In some embodiments, the OSDA is trimethyl benzyl ammonium hydroxide. In some embodiments, the OSDA is triethyl cyclohexyl ammonium hydroxide. In some embodiments, the OSDA is a combination of trimethyl adamantyl ammonium hydroxide and trimethyl benzyl ammonium hydroxide. In some embodiments, the OSDA is a combination of trimethyl adamantyl ammonium hydroxide and triethyl cyclohexyl ammonium hydroxide. In some embodiments, the OSDA is a combination of trimethyl benzyl ammonium hydroxide and triethyl cyclohexyl ammonium hydroxide.

In some embodiments, the gel is heated at about 100 °C. In some embodiments, the gel is heated at about 110 °C. In some embodiments, the gel is heated at about 120 °C. In some embodiments, the gel is heated at about 130 °C. In some embodiments, the gel is heated at about 140 °C. In some embodiments, the gel is heated at about 150 °C. In some embodiments, the gel is heated at about 160 °C. In some embodiments, the gel is heated at about 170 °C. In some embodiments, the gel is heated at about 180 °C. In some embodiments, the gel is heated at about 190 °C. In some embodiments, the gel is heated at about 200 °C. In some embodiments, the gel is heated for about 15 hours to 90 hours. In some embodiments, the gel is heated for about 16 to about 80 hours. In some embodiments, the gel is heated for 20 hours to 70 hours. In some embodiments, the gel is heated for about 25 hours to 60 hours. In some embodiments, the gel is heated for about 28 hours to 50 hours. In some embodiments, the gel is heated for about 30 hours. In some embodiments, the gel is heated for about 31 hours. In some embodiments, the gel is heated for about 32 hours. In some embodiments, the gel is heated for about 33 hours. In some embodiments, the gel is heated for about 34 hours. In some embodiments, the gel is heated for about 35 hours. In some embodiments, the gel is heated for about 36 hours. In some embodiments, the gel is heated for about 37 hours. In some embodiments, the gel is heated for about 38 hours. In some embodiments, the gel is heated for about 39 hours. In some embodiments, the gel is heated for about 40 hours. In some embodiments, the gel is heated from room temperature to a first target temperature for about 2 hours to about 4 hours. In some embodiments, the gel is heated to about 160 °C for about 5 hours to about 20 hours. In some embodiments, the gel is heated at a temperature of about 140 °C for about 30 hours to about 80 hours.

In some embodiments, the intermediate phase is heated at about 100 °C. In some embodiments, the intermediate phase is heated at about 110 °C. In some embodiments, the intermediate phase is heated at about 120 °C. In some embodiments, the intermediate phase is heated at about 130 °C. In some embodiments, the intermediate phase is heated at about 140 °C. In some embodiments, the intermediate phase is heated at about 150 °C. In some embodiments, the intermediate phase is heated at about 160 °C. In some embodiments, the intermediate phase is heated at about 170 °C. In some embodiments, the intermediate phase is heated at about 180 °C. In some embodiments, the intermediate phase is heated at about 190 °C. In some embodiments, the intermediate phase is heated at about 200 °C. In some embodiments, the intermediate phase is heated for about 30 hours. In some embodiments, the intermediate phase is heated for about 31 hours. In some embodiments, the intermediate phase is heated for about 15 hours to 90 hours. In some embodiments, the intermediate phase is heated for about 16 to about 80 hours. In some embodiments, the intermediate phase is heated for 20 hours to 70 hours. In some embodiments, the intermediate phase is heated for about 25 hours to 60 hours. In some embodiments, the intermediate phase is heated for about 28 hours to 50 hours. In some embodiments, the intermediate phase is heated for about 32 hours. In some embodiments, the intermediate phase is heated for about 33 hours. In some embodiments, the intermediate phase is heated for about 34 hours. In some embodiments, the intermediate phase is heated for about 35 hours. In some embodiments, the intermediate phase is heated for about 36 hours. In some embodiments, the intermediate phase is heated for about 37 hours. In some embodiments, the intermediate phase is heated for about 38 hours. In some embodiments, the intermediate phase is heated for about 39 hours. In some embodiments, the intermediate phase is heated for about 40 hours.

In some embodiments, the SiO₂ yield is greater than about 50%, based on complete aluminum conversion. In some embodiments, the SiO₂ yield of the zeolite is about 50%. In some embodiments, the SiO₂ yield of the zeolite is about 51%. In some embodiments, the SiO₂ yield of the zeolite is about 52%. In some embodiments, the SiO₂ yield of the zeolite is about 53%. In some embodiments, the SiO₂ yield of the zeolite is about 54%. In some embodiments, the SiO₂ yield of the zeolite is about 55%. In some embodiments, the SiO₂ yield of the zeolite is about 56%. In some embodiments, the SiO₂ yield of the zeolite is about 57%. In some embodiments, the SiO₂ yield of the zeolite is about 58%. In some embodiments, the SiO₂ yield of the zeolite is about 59%. In some embodiments, the SiO₂ yield of the zeolite is about 60%. In some embodiments, the SiO₂ yield of the zeolite is about 61%. In some embodiments, the SiO₂ yield of the zeolite is about 62%. In some embodiments, the SiO₂ yield of the zeolite is about 63%. In some embodiments, the SiO₂ yield of the zeolite is about 64%. In some embodiments, the SiO₂ yield of the zeolite is about 65%.

In some embodiments, the phase pure CHA zeolite has a matrix surface area (MSA) of less than about 40 m²/g. In some embodiments, the phase pure CHA zeolite has a MSA of between about 10 m²/g and about 25 m²/g. In some embodiments, the phase pure CHA zeolite has a MSA of about 10 m²/g. In some embodiments, the phase pure CHA zeolite has a MSA of about 11 m²/g. In some embodiments, the phase pure CHA zeolite has a MSA of about 12 m²/g. In some embodiments, the phase pure CHA zeolite has a MSA of about 13 m²/g. In some embodiments, the phase pure CHA zeolite has a MSA of about 14 m²/g. In some embodiments, the phase pure CHA zeolite has a MSA of about 15 m²/g. In some embodiments, the phase pure CHA zeolite has a MSA of about 16 m²/g. In some embodiments, the phase pure CHA zeolite has a MSA of about 17 m²/g. In some embodiments, the phase pure CHA zeolite has a MSA of about 18 m²/g. In some embodiments, the phase pure CHA zeolite has a MSA of about 19 m²/g. In some embodiments, the phase pure CHA zeolite has a MSA of about 20 m²/g. In some embodiments, the phase pure CHA zeolite has a MSA of about 21 m²/g. In some embodiments, the phase pure CHA zeolite has a MSA of about 22 m²/g. In some embodiments, the phase pure CHA zeolite has a MSA of about 23 m²/g. In some embodiments, the phase pure CHA zeolite has a MSA of about 24 m²/g. In some embodiments, the phase pure CHA zeolite has a MSA of about 25 m²/g. The MSA can be calculated using a t-plot method.

In some embodiments, the phase pure CHA zeolite has a silica to alumina ratio (SAR) of greater than about 15.0. In some embodiments, the phase pure CHA zeolite has SAR of greater than about 15.5. In some embodiments, the phase pure CHA zeolite has SAR of greater than about 16.0. In some embodiments, the phase pure CHA zeolite has SAR of greater than about 16.5. In some embodiments, the phase pure CHA zeolite has SAR of greater than about 17.0. In some embodiments, the phase pure CHA zeolite has SAR of greater than about 17.5. In some embodiments, the phase pure CHA zeolite has SAR of greater than about 18.0. some embodiments, the phase pure CHA zeolite has SAR of greater than about 18.5. In some embodiments, the phase pure CHA zeolite has SAR of about 19.0. In some embodiments, the phase pure CHA zeolite has SAR of about 19.5. In some embodiments, the phase pure CHA zeolite has SAR of about 20. In some embodiments, the phase pure CHA zeolite has SAR of about 20.5. In some embodiments, the phase pure CHA zeolite has SAR of about 21.0. In some embodiments, the phase pure CHA zeolite has SAR of about 21.5. In some embodiments, the phase pure CHA zeolite has SAR of about 21.7. In some embodiments, the incorporation of gel silica to zeolitic material results in a zeolite with a significantly lower SAR than that of the starting gel silica.

In some embodiments, the CHA zeolite a matrix surface area (MSA) less than about 40 m²/g. In some embodiments, the MSA is less than about 25 m²/g. In some embodiments, the MSA is about 24 m²/g. In some embodiments, the MSA is about 23 m²/g. In some embodiments, the MSA is about 22 m²/g. In some embodiments, the MSA is about 21 m²/g. In some embodiments, the MSA is about 20 m²/g. In some embodiments, the MSA is about 19 m²/g. In some embodiments, the MSA is about 18 m²/g. In some embodiments, the MSA is about 17 m²/g. In some embodiments, the MSA is about 16 m²/g. In some embodiments, the MSA is about 15 m²/g. In some embodiments, the MSA is about 14 m²/g. In some embodiments, the MSA is about 13 m²/g. In some embodiments, the MSA is about 12 m²/g. In some embodiments, the MSA is about 11 m²/g. In some embodiments, the MSA is about 10 m²/g.

In some embodiments, the CHA zeolite has a substantially greater CHA framework. In some embodiments, the CHA zeolite has greater than about 75% CHA framework. In some embodiments, the CHA zeolite has greater than about 80% CHA framework. In some embodiments, the CHA zeolite has greater than about 85% CHA framework. In some embodiments, the CHA zeolite has greater than about 90% CHA framework. In some embodiments, the CHA zeolite has greater than about 95% CHA framework. In some embodiments, the CHA zeolite has less than about 25% MOR framework. In some embodiments, the CHA zeolite has less than about 20% MOR framework. In some embodiments, the CHA zeolite has less than about 15% MOR framework. In some embodiments, the CHA zeolite has less than about 10% MOR framework. In some embodiments, the CHA zeolite has less than about 5% MOR framework.

In some embodiment, the sonic velocity profile of each step of the method of producing the CHA zeolite is measured. In some embodiments, the sonic velocity is measured as an ultrasonic measurement in m/s. In some embodiments, the ultrasonic measurement of the gel of step (a) is greater than about 1000 m/s. In some embodiments, the ultrasonic measurement of the intermediate phase of step (b) is about 5 m/s to about 15 m/s higher than that of the gel of step (a). In some embodiments, the ultrasonic measurement of the intermediate phase of step (b) is about 5 m/s higher than that of the gel of step (a). In some embodiments, the ultrasonic measurement of the intermediate phase of step (b) is about 9 m/s higher than that of the gel of step (a). In some embodiments, the ultrasonic measurement of the intermediate phase of step (b) is about 11 m/s higher than that of the gel of step (a). In some embodiments, the ultrasonic measurement of the intermediate phase of step (b) is about 13 m/s higher than that of the gel of step (a). In some embodiments, the ultrasonic measurement of the intermediate phase of step (b) is about 15 m/s higher than that of the gel of step (a). In some embodiments, the ultrasonic measurement of the CHA zeolite of step (c) is about 7 m/s to about 17 m/s higher than that of the gel of step (a). In some embodiments, the ultrasonic measurement of the CHA zeolite of step (c) is about 7 m/s higher than that of the gel of step (a). In some embodiments, the ultrasonic measurement of the CHA zeolite of step (c) is about 9 m/s higher than that of the gel of step (a). In some embodiments, the ultrasonic measurement of the CHA zeolite of step (c) is about 11 m/s higher than that of the gel of step (a). In some embodiments, the ultrasonic measurement of the CHA zeolite of step (c) is about 13 m/s higher than that of the gel of step (a). In some embodiments, the ultrasonic measurement of the CHA zeolite of step (c) is about 15 m/s higher than that of the gel of step (a). In some embodiments, the ultrasonic measurement of the CHA zeolite of step (c) is 17 m/s higher than that of the gel of step (a).

In some embodiments, the method of preparing a CHA zeolite includes further isolating the phase pure CHA zeolite by filtration. In some embodiments, the isolated phase pure zeolite is dried and calcined to yield the Na⁺ form. In some embodiments, the calcination takes place at greater than about 500 °C, preferably in a range of from about 500 °C to about 550 °C. In some embodiments, the calcination takes place at around about 500 °C. In some embodiments, the calcination takes place at around about 510 °C. In some embodiments, the calcination takes place at around about 520 °C. In some embodiments, the calcination takes place at around about 530 °C. In some embodiments, the calcination takes place at around about 540 °C. In some embodiments, the calcination takes place at around about 550 °C. In some embodiments, the calcination takes place for more than about 5 hours. In some embodiments, the calcination takes place for about 6 hours. In some embodiments the calcination takes place for about 7 hours.

In some embodiments, the calcined CHA zeolite is subjected to an NH₄⁺ exchange. In some embodiments, the NH₄⁺ form has a Na₂O content of less than about 500 ppm.

In some embodiments, Cu ions are introduced to the NH₄⁺ form CHA zeolite to form a zeolite catalyst without calcination. In some embodiments, the NH₄⁺ form is calcined to produce the H⁺ form. In some embodiments, the calcination takes place at greater than about 400 °C. In some embodiments, the calcination takes place at around about 410 °C. In some embodiments, the calcination takes place at around about 420 °C. In some embodiments, the calcination takes place at around about 430 °C. In some embodiments, the calcination takes place at around about 440 °C. In some embodiments, the calcination takes place at around about 450 °C. In some embodiments, the calcination takes place for more than about 5 hours. In some embodiments, the calcination takes place for about 6 hours. In some embodiments the calcination takes place for about 7 hours.

In some embodiments, a zeolite catalyst is formed by introducing Cu ions to the H⁺ form CHA zeolite. In some embodiments, the zeolite catalyst has a copper loading ranging about 3.0 wt % to about 6.0 wt. %. In some embodiments, the zeolite catalyst has a copper loading ranging about 3.5 wt % to about 5.5 wt. %. In some embodiments, the zeolite catalyst has a copper loading ranging about 4.0 wt % to about 5.0 wt. %. In some embodiments, the zeolite catalyst has a copper loading ranging about 4.7 wt % to about 5.0 wt. %. In some embodiments, the zeolite catalyst has a copper loading of about 3.0 wt. %. In some embodiments, the zeolite catalyst has a copper loading of about 3.5 wt. %. In some embodiments, the zeolite catalyst has a copper loading of about 4.0 wt. %. In some embodiments, the zeolite catalyst has a copper loading of about 4.5 wt. %. In some embodiments, the zeolite catalyst has a copper loading of about 4.8 wt. %. In some embodiments, the zeolite catalyst has a copper loading of about 4.9 wt. %. In some embodiments, the zeolite catalyst has a copper loading of about 5.0 wt. %. In some embodiments, the zeolite catalyst has a copper loading of about 5.5 wt. %. In some embodiments, the zeolite catalyst gas a copper loading of about 6.0 wt. %. In some embodiments, the copper loading is expressed as CuO content.

In some embodiments, the zeolite has a silica to alumina ratio (SAR) ranging from about 20 to about 22. In some embodiments, the zeolite has an SAR of about 20. In some embodiments, the zeolite has an SAR of about 21. In some embodiments, the zeolite has an SAR of about 22. Another aspect of the present disclosure is a method of producing a catalytic article. In some embodiments, the method comprises coating a substrate with a catalytic coating via a wash coat process. In some embodiments, the method further comprises drying and calcining the coated substrate at a temperature greater than about 500 °C, preferably for about 1 hour or more, more preferably of about 550 °C for about 1 hour. In some embodiments, the catalytic coating comprises the CHA zeolite as described in the present disclosure with a copper loading ranging from about 4.7 wt % to about 5.0 wt %. In some embodiments, the catalytic coating further comprises about 5% zirconium oxide. In some embodiments, the catalytic coating further comprises about 5% pseudoboehmite (PB-250) binder.

In another aspect of the present disclosure, there is provided a catalytic article comprising a copper-exchanged CHA zeolite. In some embodiments, the CHA zeolite of the present disclosure has a zeolite surface area (ZSA) greater than about 450 m²/g. In some embodiments, the CHA zeolite of the present disclosure has a matrix surface area (MSA) less than about 40 m²/g. The total surface area of a zeolite can be determined by BET methods. The matrix or mesopore surface area (MSA) can be calculated using a t-plot method. The ZSA may be then calculated by subtracting MSA from the total surface area. The ZSA relates to the copper loaded zeolite. In another aspect of the present disclosure, there is provided a copper-exchanged CHA zeolite, obtained or obtainable by the afore-mentioned method.

Another aspect of the present disclosure provides for a method of reducing nitrogen oxides (NOₓ). In some embodiments, the method comprises contacting a gaseous stream containing nitrogen oxides with at least one copper exchanged CHA zeolite of the present disclosure. In some embodiments, the method comprises contacting a gaseous stream containing nitrogen oxides with at least one catalytic article of the present disclosure. In some embodiments, the method of reducing nitrogen oxide is at a temperature ranging from about 200 °C to about 550 °C. In some embodiments, the method of reducing nitrogen oxides is at about 200 °C. In some embodiments, the method of reducing nitrogen oxides is at about 250 °C. In some embodiments, the method of reducing nitrogen oxides is at about 300 °C. In some embodiments, the method of reducing nitrogen oxides is at about 350 °C. In some embodiments, the method of reducing nitrogen oxides is at about 400 °C. In some embodiments, the method of reducing nitrogen oxides is at about 450 °C. In some embodiments, the method of reducing nitrogen oxides is at about 500 °C. In some embodiments, the method of reducing nitrogen oxides is at about 550 °C.

Zeolites of the present disclosure may be deposited on a substrate. The substrate may be any material typically used for preparing catalysts, such as, e.g., a substrate with a ceramic or a metal honeycomb structure. Any suitable substrate may be employed, such as, e.g., a monolithic substrate having fine, parallel gas flow passages extending therethrough from an inlet or an outlet face of the substrate, such that passages are open to fluid flow therethrough (referred to as honeycomb flow through substrates). The passages, which may be essentially straight paths from their fluid inlet to their fluid outlet, can be defined by walls on which the zeolites deposited as a washcoat so that gases flowing through the passages contact the zeolites. The flow passages of the monolithic substrate may be thin-walled channels, which can be of any suitable cross-sectional shape and size, such as, e.g., trapezoidal, rectangular, square, sinusoidal, hexagonal, oval, or circular cross-sections. Such structures may contain from about 60 to about 400 or more gas inlet openings (i.e., cells) per square inch of cross-section.

The substrate can also be a wall-flow filter substrate, where the channels are alternately blocked, allowing a gaseous stream entering the channels from one direction (inlet direction), to flow through the channel walls and exit from the channels from the other direction (outlet direction). Zeolites of the present disclosure can be coated on the flow through or wall-flow filter. If a wall flow substrate is utilized, the resulting system may be able to remove particulate matter along with gaseous pollutants such as, e.g., nitrogen oxides. The wall-flow filter substrate can be made from materials commonly known in the art, such as, e.g., cordierite, aluminum titanate, or silicon carbide. It will be understood that the loading of zeolites on a wall flow substrate will depend on substrate properties such as porosity and wall thickness, and typically will be lower than loading on a flow through substrate.

A ceramic substrate may be made of any suitable refractory material, such as, e.g., cordierite, cordierite-alumina, silicon nitride, zircon mullite, spodumene, alumina-silica magnesia, zircon silicate, sillimanite, a magnesium silicate, zircon, petalite, alpha-alumina, or an aluminosilicate etc.

Substrates useful for zeolites of the present disclosure may also be metallic in nature and be composed of one or more metals or metal alloys. The metallic substrates may be employed in various shapes, such as, e.g., corrugated sheet or monolithic form. Suitable metallic supports include the heat resistant metals and metal alloys, such as, e.g., titanium and stainless steel as well as other alloys in which iron is a substantial or major component. Such alloys may contain one or more of nickel, chromium, and/or aluminum, and the total amount of these metals may comprise at least about 15 wt. % of the alloy, e.g., about 10 to about 25 wt. % of chromium, about 3 to about 8 wt. % of aluminum and up to about 20 wt. % of nickel. The alloys may also contain small or trace amounts of one or more other metals, such as, e.g., manganese, copper, vanadium, or titanium. The surface or the metal substrates may be oxidized at high temperatures, such as, e.g., about 1000 °C and higher, to improve corrosion resistance by forming an oxide layer on the substrates' surface. High temperature-induced oxidation may enhance the adherence of the refractory metal oxide support and catalytically promoting metal components to the substrate.

Before describing exemplary embodiments of the present disclosure, it is to be understood that the disclosure is not limited to the details of construction or process steps set forth in the following examples and is capable of other embodiments and of being practiced or being carried out in various ways.

### EXAMPLES

### Example 1

Gel compositions and crystallization conditions leading to Comparative Zeolites 1 and 2 and Exemplary Zeolites 3 and 4 are outlined in Table 1, below, and the characteristics of the resulting products are presented in Table 2, below.

TABLE 1
Composition of gels and crystallization conditions

| | Comparative | Comparative | Exemplary | Exemplary |
|---|---|---|---|---|
| Composition | Zeolite 1 | Zeolite 2 | Zeolite 3 | Zeolite 4 |
| Al Source | Al(i-C₃H₇O)₃ | Na-FAU | Na-FAU | Na-FAU |
| Si Source | Coll. SiO₂ | Na silicate | Na silicate | Na silicate |
| OSDA | TMAdaOH | TMAdaOH | TMAdaOH | TMAdaOH |
| SiO₂/Al₂O₃ | 20 | 29.19 | 29.19 | 29.19 |
| Na/Si | 0.13 | 0.82 | 0.82 | 0.82 |
| R/Si | 0.071 | 0.091 | 0.091 | 0.091 |
| OH/Si | 0.2 | 0.509 | 0.509 | 0.509 |
| H₂O/Si | 11 | 21.60 | 32.05 | 32.05 |
| T (°C) | 170 | 140 | 140 | 140 |
| Time at T | 30 | 30 | 88 | 80 |
| (h) | | | | |
| Solids (%) | 22 | 12.4 | 9.1 | 9.1 |

TABLE 2
Properties of zeolite products

| | Comparative | Comparative | Exemplary | Exemplary |
|---|---|---|---|---|
| Product | Zeolite 1 | Zeolite 2 | Zeolite 3 | Zeolite 4 |
| Phase | 94% CHA, | 94% CHA, | 95% CHA, | 93% CHA, |
| Comp. | Amorphous | Amorphous | Amorphous | 7% MOR |
| SiO₂/Al₂O₃ | 18.4 | 16.9 | 16.1 | 16.5 |
| SiO₂ yield ( | 92 | 58 | 55 | 57 |
| ZSA (m²/g) | 512 | 592 | 561 | 577 |
| MSA (m²/g) | 43 | 20 | 11 | 15 |
| EF-Al (%) | 24 | — | 10 | 10 |

Trimethyladamantylammonium hydroxide (TMAdaOH) was used as organic structure directing agents (OSDA) for CHA crystallizations.

For Comparative Zeolite 1, NaOH was used as the mineralizing agent and the sole source of Na⁺ in the gel, and aluminum isopropoxide and colloidal silica (40 wt % SiO₂) acted as Si and Al sources respectively. For Comparative Zeolite 2 and Exemplary Zeolites 3 and 4 (as well as for zeolites E, F, H, and I, described in Table 7 below), a sodium silicate solution (SiO₂/Na₂O=2.6, 37% solids content) and Na-FAU (SiO₂/Al₂O₃=5.1) were used as Si and Al sources respectively.

The gel Na⁺ content was supplemented with Na₂SO₄ to reach the desired Na/Si ratio. Furthermore, the desired OH/Si ratio was obtained via neutralization of excess OH⁻ with H₂SO₄. A 1:1 ratio between Na⁺ and OH⁻ was assumed for the sodium silicate solution to calculate OH⁻/SiO₂ ratio.

In all cases, crystallization was conducted in 10-110 L stirred autoclaves at autogenous pressure. During crystallization, the ultrasonic measuring instrument Sensotech LiquiSonic Immersion Sensor 24-24 was used to in-site and continuously measure sonic velocity of reactor slurry. The measuring method is based on the determination of the speed of propagation of ultrasonic waves in liquid media.

Reactor slurry samples were taken at various times during crystallization. The in-process samples and final products were isolated by filtration, dried and calcined (560 °C, 6 h) to yield the Na⁺ form, which was characterized by XRD and N₂-Physisorption. Panalytical HighScore version 4.5 software and ICDD PDF 4+2019 version 4.1903 powder diffraction file database was used for phase identification analysis. Rietveld refinement was done using Topas 4.2 to determine MOR percent. Following calcination, single or multiple NH₄⁺ exchanges were performed until Na₂O content reached <500 ppm. Calcination of the NH₄⁺ form (450 °C, 6h) yielded the H⁺ form. Copper loading (via in-situ solid-state exchange) was also performed on the H⁺ form of the zeolites.

All crystallizations yielded products with >90% primary phase crystallinity, and correspondingly high ZSA (>500 m²/g). For Comparative Zeolite 1, the gel silica to alumina ratio (SAR) is similar to product SAR, in accordance with >90% silica yields (based on complete aluminum conversion). In Comparative Zeolite 2 and Exemplary Zeolites 3 and 4, the silica yield varied from 55-58% and is consistent with the large difference between gel and product SAR.

The Comparative and Exemplary zeolites also manifest important structural differences during crystallization. Firstly, the MSA of Comparative Zeolites 1 and 2 ranges from 20-50 m²/g whereas, Exemplary Zeolites 3 and 4 display an MSA<15 m²/g. Furthermore, the H⁺ forms of Exemplary Zeolites 3 and 4 contain 30-50% less extra-framework aluminum than corresponding Comparative Zeolites 1 and 2 with similar SARs. Dealumination usually takes place during the calcination of the as prepared and NH₄⁺ forms, and the tendency to retain framework Al during these high temperature treatments, may also be related to hydrothermal stability. Measurement of silanol defect densities in comparative zeolites 1 and 2, as compared to exemplary zeolite 3 also highlight the structural differences in the zeolite products obtained. The density of Si—OH/g zeolite as determined from ¹H MAS NMR measurements for zeolites 1, 2 and 3 are 0.21, 0.38 and 0.09 mmol/g zeolite respectively.

Measurement of silanol was carried out as follows. Samples were packed in 6 mm outer diameter glass tubes. They were then heated in a vacuum oven with the following temperature protocol: heated from room temperature to 120 °C, over 2 h, maintained at 120 °C for 2 h, heated from 120 °C to 400 °C, over 3 h, maintained at 400 °C, for 12 h, then finally cooled while maintaining a vacuum. A vacuum of <10⁻² hPa was maintained during this process. The samples were then repacked into 3.2 mm closed-bottom ZrO₂ rotors under dry N₂ gas to avoid any contact with air. ¹H MAS NMR was run at 600 MHz, 15 kHz MAS, 90° pulse, dead time delay of 20 μs, 20 ms FID acquisition, 30 s recycle delay and with 32 scans.

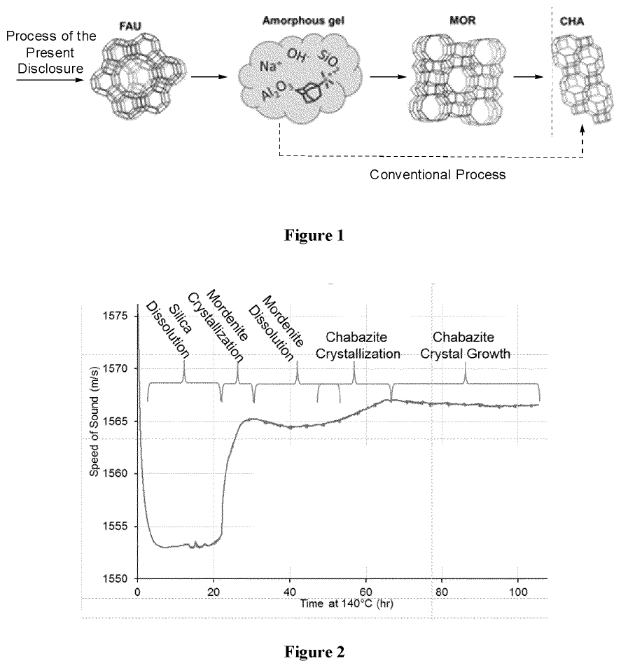

Most importantly, Exemplary Zeolites 3 and 4 went through an MOR phase (as shown in FIGS. 1 and 2) before formation of the CHA phase. Sonic velocity also correlated well with phase transitions (FIG. 2).

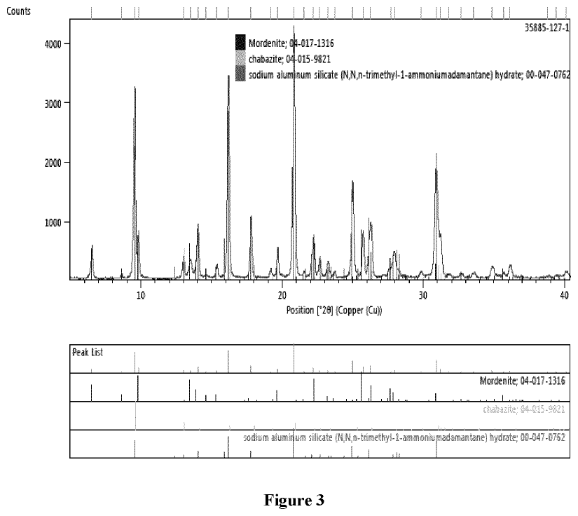

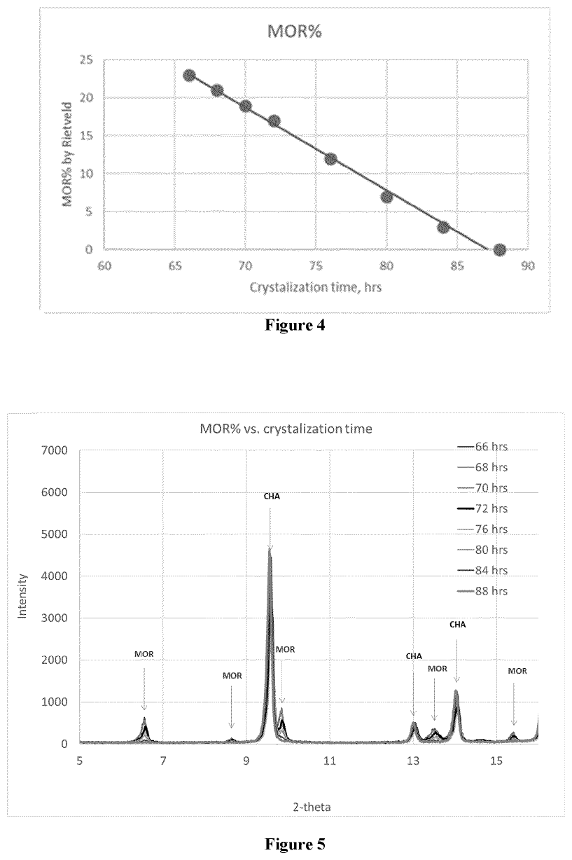

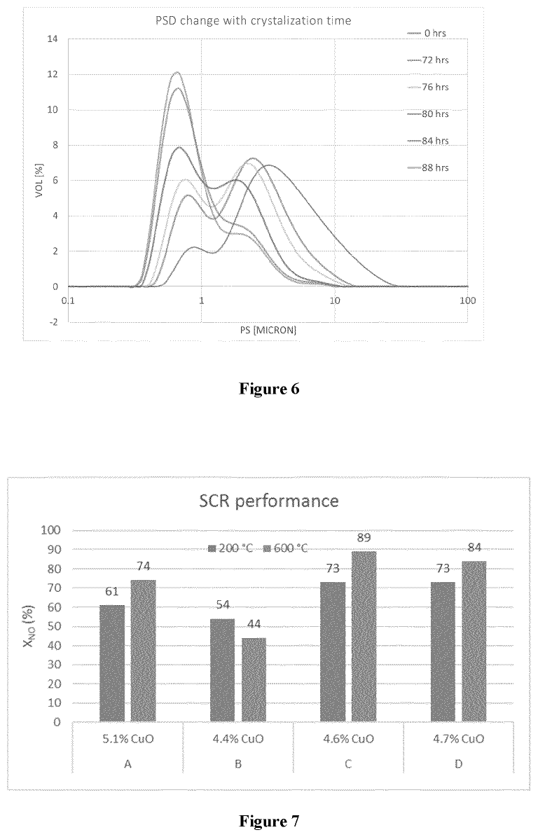

A set of intermediate in-process samples were taken during the crystallization process of Exemplary Zeolite 3. Exemplary Zeolite 4 is an in-process sample of Exemplary Zeolite 3, taken at 80 hours, which still contained 7% MOR. The MOR percent decreases with crystallization time while CHA percent increases, as shown in FIGS. 3, 4 and 5. Particle size distribution also responded well with MOR percent, where the second peak decreases and the first peak increases with decreasing MOR (FIG. 6).

The differences in synthetic pathways can be used to minimize defect density, which in turn results in enhanced hydrothermal stability and improved SCR catalytical performance, as shown in FIG. 7.

### Example 2

Comparative Zeolite 1 (also described above, in Example 1) with a silica to alumina mole ratio (SAR) of 18 was prepared with NaOH as the mineralizing agent, and aluminum isopropoxide (AIP) and colloidal silica (40 wt. % SiO₂) as the silica and alumina sources, respectively.

Sodium silicate (with a SiO₂/Na₂O wt % ratio of 3.3 and a 37 wt. % solids content) and aluminum isopropoxide served as the primary silica and alumina sources, respectively, for the gels in Exemplary Zeolite 6 and Exemplary Zeolite 7.

The gel compositions of Comparative Zeolite 1, Exemplary Zeolite 6 and Exemplary Zeolite 7 are outlined in Table 3, below.

TABLE 3
Mole ratio composition of gels

| | Comparative | Exemplary |
|---|---|---|
| | Zeolite 1 | Zeolites 6 and 7 |
| SiO₂/Al₂O₃ | 20 | 35 |
| Na/Si | 0.13 | 0.87 |
| OSDA/Si | 0.07 | 0.09 |
| OH/Si | 0.2 | 0.53 |
| H₂O/SiO₂ | 11 | 15.3 |

In Exemplary Zeolite 7, a fraction (10% on a total silica bases) of the sodium silicate and aluminum isopropoxide was substituted with a zeolite initiator commonly used to crystallize zeolite Y. This material, comprising a SiO₂/Al₂O₃ molar ratio of 65, SiO₂/Na₂O molar ratio of 1.7, and H₂O/SiO₂ molar ratio of 10.3, is referred to as “FAU seeds.” Zeolite initiators are also interchangeable referred to and known by those skilled in the art as “NaY seeds”

The gel Na/Si and OH/Si ratios were adjusted by addition of Na₂SO₄ and H₂SO₄, respectively. Trimethyladamantylammonium hydroxide (TMAdaOH) was used as the organic structure directing agent (OSDA) for all crystallizations. Further details of gel composition and crystallization conditions are summarized in Table 4.

TABLE 4
Gel composition and crystallization conditions for Comparative
Zeolite 1 and Exemplary CHA Zeolites 6 and 7

| | Gel properties | | | | | | | |
|---|---|---|---|---|---|---|---|---|
| | Al | Al | Si | Si | | Si | Al | |
| | Source | Source | Source | Source | Solids | source 1/ | source 1/ | Time(h)/ |
| Examples | 1 | 2 | 1 | 2 | Content | Si-total | Al-total | Temp.(°C) |
| Comparative | AIP | — | Colloidal | — | 22% | 100% | 100% | 30/170 |
| Zeolite 1 | | | SiO₂ | | | | | |
| Exemplary | AIP | — | Na | — | 15% | 100% | 100% | 72/140 |
| Zeolite 6 | | | Silicate | | | | | |
| Exemplary | AIP | FAU | Na | FAU | 15% | 90% | 94% | 72/140 |
| Zeolite 7 | | Seeds | Silicate | Seeds | | | | |

Initial crystallization experiments were carried out in 300 mL stirred autoclaves for 15 h and 36 h (Comparative Zeolite 1) and 36 h and 72 h (Exemplary Zeolites 6 and 7). An amorphous/CHA phase mixture was observed after 15 h crystallization of the Comparative Zeolite 1 gel, and fully crystalline, phase pure CHA was observed after 30 h.

For the Exemplary Zeolites 6 and 7, phase mixtures of MOR and CHA were observed at an intermediate crystallization time (36 h), eventually converting into phase pure CHA at 72 h. Taken together these results suggest the direct crystallization of CHA from an amorphous gel for the Comparative Zeolite 1, and the formation of a labile MOR intermediate phase for the Exemplary Zeolites 6 and 7.

Larger quantities of material for SCR testing were prepared in 2 L stirred autoclaves. The products were isolated by filtration, dried and calcined in air (540 °C, 6 h) to yield the Na⁺ form, which was characterized by XRD and N₂-Physisorption.

Procedure for XRD characterization: The samples were ground using a mortar and pestle and then backpacked into a flat mount sample holder. A PANalytical MPD X'Pert Pro diffraction system was used for data collection. A copper anode tube (Wavelength: Cu Kα1=1.54060 Å) was operated at 45 kV and 40 mA. The Bragg-Brentano configuration was employed, and data was acquired from 3° to 80° 2θ with a step size of 0.016° and a count-time of 60 s/step.

Pore volume and surface area characteristics can be determined by nitrogen adsorption (BET surface area method). Mesopore and zeolitic (micropore) surface areas were determined via N₂-adsorption porosimetry on a Micromeritics TriStar 3000 series instrument, in accordance with ISO 9277 methods.

Procedure for N₂-Physisorption: Zeolite BET surface area analysis and nitrogen pore size distribution were analyzed on Micromeritics TriStar 3000 series instruments. The samples were degassed for a total of 6 hours (a 2 hour ramp up to 300 °C then held at 300 °C for 4 hours, under a flow of dry nitrogen) on a Micromeritics SmartPrep degasser. Nitrogen BET surface area is determined using 5 partial pressure points between 0.08 and 0.20. Nitrogen pore size (BJH) is determined using 33 desorption points.

Zeolitic and matrix surface areas are determined using the same 5 partial pressure points and calculated using Harkins and Jura t-plot. Pores having diameter greater than 20 Å are considered to contribute to matrix surface area.

Following calcination, an NH₄⁺ exchange was performed, leading to an Na₂O content of <500 ppm. Calcination of the NH₄⁺ form (450 °C, 6 h) yielded the H⁺ form. The properties of these phase pure CHA products in Na⁺ form are summarized in Table 5.

TABLE 5
Product properties for Comparative Zeolite
1 and Exemplary Zeolites 6 and 7

| | Product Properties | | | | | |
|---|---|---|---|---|---|---|
| | SiO₂ | Intermediate | Final | | ZSA | MSA |
| Examples | Yield | Phase | Phase | SAR | (m²/g) | (m²/g) |
| Comparative | 93% | CHA + AMPH | CHA | 18.4 | 512 | 43 |
| Zeolite 1 | | | | | | |
| Exemplary | 57% | MOR + CHA | CHA | 20.1 | 514 | 22 |
| Zeolite 6 | | | | | | |
| Exemplary | 62% | MOR + CHA | CHA | 21.7 | 578 | 13 |
| Zeolite 7 | | | | | | |

Assuming complete conversion of gel alumina into zeolitic material, the silica yield for each crystallization can be calculated from the respective gel and product SARs. This yield is over 90% for Comparative Zeolite 1 and about 60% for the Exemplary Zeolites 6 and 7. It should also be noted that even though all CHA materials display a zeolitic surface area, characteristic of highly crystalline CHA (>500 m²/g), Exemplary Zeolites 6 and 7 possess a significantly lower matrix surface area than Comparative Zeolite 1.

To prepare SCR catalysts from the aforementioned materials, Cu ions were introduced to the H⁺ form zeolites to attain the target CuO loading of 4.7-5.0 wt. %. Catalytic coatings containing Cu-CHA, zirconium oxide and pseudoboehmite (PB-250) binder were disposed via a washcoat process on cellular ceramic monoliths having a cell density of 400 cpsi and a wall thickness of 6 mil. The coated monoliths were dried at 110-150 °C and calcined at about 550 °C for 1 hour. The coating process provides a catalyst loading of 2.1 g/in³ of which 5% is zirconium oxide and 5% is aluminum oxide binder. The coated monoliths were hydrothermally aged in the presence of 10% H₂O/air either at 800 °C for 16 hours or 850 °C for 16 hours, as specified. For aging at 650 °C for 50 hours, the cores were exposed to 3 liters per minute of gas (Composition: 10% 02, 10% H₂O, rest nitrogen) flow.

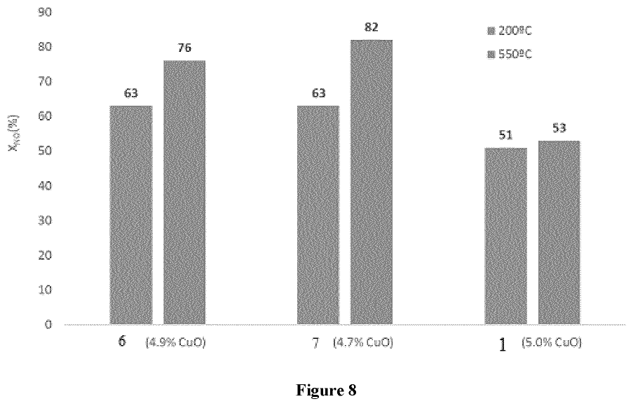

NOₓ conversions for the 800 °C/16 h and 850 °C/16 h aged materials (as shown in FIG. 8 and Table 8) were measured in a laboratory reactor at a gas hourly volume-based space velocity of 80,000 h⁻¹ under pseudo-steady state conditions in a gas mixture of 500 ppm NO, 500 ppm NH₃, 10% O₂, 5% H₂O, balance N₂ in a temperature ramp of 5 °C/min from 200 °C to 550 °C. For the 650 °C/50 h aged materials (except comparative material J), NOₓ conversions were measured on coated cores (subjected to the hydrothermal aging treatment specified earlier) in a reactor at a gas hourly volume-based space velocity of 60,000 h⁻¹ under steady state conditions in a gas mixture of 1000 ppm NO, 1050 ppm NH₃, 10% O₂, 8% CO₂, 7% H₂O, balance N₂ at discrete temperature points as the catalyst is heated after allowing for sufficient time for steady state (thermal and gas composition) to be attained. Comparative sample J after 650 °C/50 h aging was tested at a gas hourly volume-based space velocity of 120,000 h⁻¹ under steady state conditions in a gas mixture of 1000 ppm NO, 1050 ppm NH₃, 10% O₂, 6% H₂O, balance N₂ at discrete temperature points as the catalyst is heated after allowing for sufficient time for steady state (thermal and gas composition) to be attained. % recovery after sulfation-desulfation treatment (Table 8) was measured on 650 °C/50 h aged cores subjected to sulfation treatment followed by a desulfation treatment prior to testing at the same conditions as the 650 °C/50 h aged cores prior to these treatments. Sulfation treatment was carried out at 400 °C under flowing gas with the composition 140 ppm SOx (SO₂+SO₃; SO₃/SOₓ=0.7), 10% O₂, 10% H₂O, balance N₂ for 8 hours, amounting to a total S exposure of about 40 g per L. For the desulfation treatment, the sulfated cores were maintained at 550 °C under flowing gas with the composition 10% O₂, 10% H₂O, balance N₂ for 0.5 hours.

Although possessing similar SARs and copper loadings, the catalysts prepared from Exemplary Zeolites 6 and 7 show superior NO conversion at 200 °C and 550 °C, as compared to a catalyst prepared from Comparative Zeolite 1.

Furthermore, Exemplary Zeolite 7, where the CHA yielding gel is partially composed of FAU seeds, shows higher NO conversion at 550 °C than the catalysts prepared from Exemplary Zeolite 6 (sodium silicate only).

These results suggest that catalysts prepared from present disclosure CHA materials (e.g., Exemplary Zeolites 6 and 7) possess a superior hydrothermal stability and an improved SCR activity (NOx conversion) after hydrothermal aging, compared with a catalyst derived from conventional procedures (e.g., Comparative Zeolite 1).

### Example 3

The following exemplary zeolites are made using non-zeolitic Al sources, as shown in Tables 6 and 7, below.

TABLE 6
Synthesis details for inventive and comparative examples

| | Raw Materials | | | Gel Composition | | | | | | Crystallization | |
|---|---|---|---|---|---|---|---|---|---|---|---|
| | Si | Al | | | Na/ | K/ | R/ | OH/ | H₂O/ | Temp | Time |
| Material | source | source \hat{ } | R | SAR | Si | Si | Si | Si | Si | (°C) | (h) |
| A | N-brand | AIP | TMAdaOH | 35.6 | 0.85 | — | 0.094 | 0.53 | 15.74 | 140 | 72 |
| | Na Silicate | | | | | | | | | | |
| B | FAU seeds, | AIP, | TMAdaOH | 35.6 | 0.85 | — | 0.094 | 0.53 | 15.74 | 140 | 72 |
| | N-brand | FAU | | | | | | | | | |
| | Na Silicate | seeds | | | | | | | | | |
| C | FAU seeds, | AIP, | TMAdaOH | 35.6 | 0.85 | — | 0.094 | 0.53 | 15.74 | 140 | 72 |
| | N-brand | FAU | | | | | | | | | |
| | Na Silicate | seeds | | | | | | | | | |
| D | FAU seeds, | AIP, | TMAdaOH | 30.0 | 0.85 | — | 0.094 | 0.47 | 15.74 | 160- | 72 |
| | N-brand | FAU | | | | | | | | 140^{&} | |
| | Na Silicate | seeds | | | | | | | | | |
| E | Na silicate | Na- | TMAdaOH | 27.0 | 0.82 | — | 0.063 | 0.38 | 18.13 | 160 | 48 |
| | | FAU | | | | | | | | | |
| F | Na silicate | Na- | TMAdaOH | 35.2 | 0.84 | — | 0.194 | 0.52 | 16.05 | 140 | 30 |
| | | FAU | | | | | | | | | |
| G | HiSil 233 | Na- | TMAdaOH | 35.2 | 0.84 | — | 0.095 | 0.56 | 16.41 | 140 | 72 |
| | | FAU | | | | | | | | | |
| H | Na silicate | Na- | TMAdaOH | 35.4 | 0.82 | — | 0.063 | 0.51 | 18.13 | 160 | 30 |
| | | FAU | | | | | | | | | |
| I | Na silicate | K-LTL | TMAdaOH | 35.1 | 0.83 | 0.063 | 0.063 | 0.51 | 16.49 | 140 | 72 |
| J | FAU seeds, | Na- | TMAdaOH | 35.6 | 0.85 | — | 0.094 | 0.45 | 16.33 | 140 | 30 |
| | N-brand | FAU, | | | | | | | | | |
| | Na Silicate | FAU | | | | | | | | | |
| | | seeds | | | | | | | | | |
| K | FAU seeds, | AIP, | TMAdaOH | 35.6 | 1.05 | — | 0.094 | 0.53 | 15.74 | 140 | 30 |
| | N-brand | FAU | | | | | | | | | |
| | Na Silicate | seeds | | | | | | | | | |
| L | Sodium | Na- | TMAdaOH | Example D form WO 2019/180663 A1 | | | | | | | |
| | silicate | FAU | | | | | | | | | |

\hat{ } Na-FAU and K-LTL denote FAU and LTL zeolites; recipes using FAU seeds are described in U.S. Pat. No. 6,908,603 B2
^{&}Crystallization was done using a staged temperature program: 8 h ramp from 25 °C to 160 °C; 10 h hold at 160 °C; 2 h cool to 140 °C; 50 h at 140 °C

TABLE 7
Product Details for Comparative and Exemplary Zeolites A-L

| | | Intermediate | | | Exemplary / |
|---|---|---|---|---|---|
| Material | Phase | MOR observed | SAR | Na/Al | Comparative |
| A | CHA | Yes (30 h) | 19.9 | 0.86 | Exemplary |
| B | CHA | Yes (30 h) | 21.4 | 0.83 | Exemplary |
| C | CHA | Yes (15 h) | 21.0 | 0.65 | Exemplary |
| D | CHA | Yes (30 h) | 18.4 | 0.46 | Exemplary |
| E | CHA | Yes (30 h) | 17.4 | 0.51 | Exemplary |
| F | CHA | No | 17.0 | 0.70 | Comparative |
| G | CHA | No (30 h) | 16.6 | — | Comparative |
| H | CHA | No | 19.5 | 0.83 | Comparative |
| I | CHA | No | 18.3 | 0.84 | Comparative |
| J | CHA | No | 18.3 | 0.84 | Comparative |
| K | CHA | No | 17.6 | 0.73 | Comparative |
| L | CHA | No | 11.4 | — | Comparative |

A zeolite initiator, listed as FAU seeds in Table 6 is the same as that described as NaY seeds in U.S. Pat. No. 6,908,603 B2. No crystalline peaks were observed when an XRD pattern was measured for this material, indicating a lack of any crystallinity. Similar gel compositions were used in the synthesis of zeolites A through K, with sulfuric acid being added to adjust the OH/Si ratio as needed. All the comparative zeolites shown in Table 6 (with the exception of zeolite K; i.e., F-J and L) were synthesized via an inter-zeolite conversion since a zeolitic Al source was used to prepare these zeolites. SEM image (not shown) were obtained for all the zeolites prepared.

SCR performance of the Cu-containing CHA catalysts is measured as the percentage of nitrogen oxides (NOx) in the feed stream that are reduced at a certain temperature. For simplicity, comparative SCR performance is shown in Table 8, below, normalized to specific reference materials (as indicated) after different simulated aging protocols. The last column of Table 8 shows SCR performance that is recovered on the catalysts after desulfation treatment at 550 °C, i.e., the SCR performance after desulfation normalized to the SCR performance prior to sulfur exposure of the catalyst. A higher extent of performance recovery indicates catalysts that are more stable and active since they are not affected by exposure to sulfur oxides. It is clear from these examples that the exemplary zeolites of the present disclosure, which are synthesized after the formation of an MOR intermediate phase, show favorable features as SCR catalysts over similar material made with similar raw materials and gel conditions without the appearance of an intermediate MOR phase.

TABLE 8
SCR Performance data for Comparative and Exemplary Zeolites A-L

| | 800 °C/16 h aged | | | 850 °C/16 h aged | | | 650 °C/16 h aged | | | % Recovery |
|---|---|---|---|---|---|---|---|---|---|---|
| | performance | | | performance | | | performance | | | (200 °C) |
| | normalized to | | | normalized to | | | normalized to | | | after |
| | Exemplary zeolite 3 | | | Exemplary zeolite 3 | | | Exemplary zeolite L | | | sulfation- |
| | CuO | 200 °C | 550 °C | CuO | 200 °C | 550 °C | CuO | 200 °C | 550 °C | desulfation |
| Material | (wt %) | (%) | (%) | (wt %) | (%) | (%) | (wt %) | (%) | (%) | treatment |
| A | 4.9 | 103.3 | 88.4 | — | — | — | — | — | — | — |
| B | 4.7 | 103.3 | 95.3 | — | — | — | — | — | — | — |
| C | 4.8 | 97.2 | 84.1 | 4.8 | 43.1 | 68.8 | — | — | — | — |
| D | — | — | — | — | — | — | 5.7 | 97.8 | 100.0 | 89 |
| E | 4.5 | 94.0 | 97.8 | — | — | — | 5.1 | 115.9 | 103.2 | 71 |
| F | 5.0 | 75.7 | 61.2 | — | — | — | — | — | — | — |
| G | 5.3 | 80.8 | 57.0 | — | — | — | — | — | — | — |
| H | 4.6 | 86.7 | 85.1 | — | — | — | — | — | — | — |
| I | 4.6 | 94.5 | 77.9 | — | — | — | — | — | — | — |
| J | — | — | — | 4.4 | 6.9 | 35.1 | 5.4 | 86.7 | 94.4 | — |
| K | — | — | — | — | — | — | 6.4 | 100.0 | 87.2 | — |
| L | — | — | — | — | — | — | 7.1 | 100.0 | 100.0 | 50 |

### EMBODIMENTS

The present invention is further illustrated by the following set of embodiments and combinations of embodiments resulting from the dependencies and back-references as indicated. In particular, it is noted that in each instance where a range of embodiments is mentioned, for example in the context of a term such as “The method of any one of embodiments 1 to 4”, every embodiment in this range is meant to be explicitly disclosed for the skilled person, i.e. the wording of this term is to be understood by the skilled person as being synonymous to “The method of any one of embodiments 1, 2, 3 and 4”. Further, it is explicitly noted that the following set of embodiments represents a suitably structured part of the general description directed to preferred aspects of the present invention, and, thus, suitably supports, but does not represent the claims of the present invention.

1. A method of preparing a chabazite (CHA) zeolite, the method comprising the steps of:
(a) preparing an aqueous mixture comprising a silica source, an alumina source, a mineralizing agent, and an organic structure directing agent (OSDA) to form a gel;
(b) heating the gel at about 100 °C to about 200 °C to form an intermediate phase comprising mordenite (MOR) crystals; and
(c) further heating the intermediate phase at about 100 °C to about 200 °C to obtain a CHA zeolite, wherein the CHA zeolite preferably has a substantially greater CHA framework.
   2. The method according to embodiment 1, wherein the CHA zeolite comprises less than about 10% MOR crystals.
   3. The method according to embodiment 1 or 2, wherein the CHA zeolite is free of MOR crystals.
   4. The method according to any one of embodiments 1-3, wherein step (b) is maintained for less than about 100 hours.
   5. The method according to any one of embodiments 1-4, wherein step (b) is maintained for about 15 hours to 90 hours, preferably for about 16 to about 80 hours, more preferably for 20 hours to 70 hours, more preferably for about 25 hours to 60 hours, more preferably for about 28 hours to 50 hours, more preferably for about 30 hours to about 40 hours.
   6. The method according to any one of embodiments 1-5, wherein step (c) is maintained for about 15 hours to 90 hours, preferably for about 16 to about 80 hours, more preferably for 20 hours to 70 hours, more preferably for about 25 hours to 60 hours, more preferably for about 28 hours to 50 hours, more preferably for about 30 hours to about 40 hours.
   7. The method according to any one of embodiments 1-6, wherein the CHA zeolite has a matrix surface area (MSA) of less than about 40 m²/g.
   8. The method according to any one of embodiments 1-7, wherein the CHA zeolite has a matrix surface area (MSA) of less than about 25 m²/g.
   9. The method according to any one of embodiments 1-8, wherein the CHA zeolite has a matrix surface area (MSA) of less than about 22 m²/g.
   10. The method according to any one of embodiments 1-9, wherein the CHA zeolite has a matrix surface area (MSA) of less than about 15 m²/g.
   11. The method according to any one of embodiments 1-10, wherein the CHA zeolite has a matrix surface area (MSA) of about 13 m²/g.
   12. The method according to any one of embodiments 1-11, wherein the CHA zeolite has a silica to alumina ratio (SAR) of greater than about 15.
   13. The method according to any one of embodiments 1-12, wherein the CHA zeolite has a silica to alumina ratio (SAR) of greater than about 18.5.
   14. The method according to any one of embodiments 1-13, wherein the CHA zeolite has a silica to alumina ratio (SAR) of greater than about 20.0.
   15. The method according to any one of embodiments 1-14, wherein the CHA zeolite has a silica to alumina ratio (SAR) of about 20.1.
   16. The method according to any one of embodiments 1-14, wherein the CHA zeolite has a silica to alumina ratio (SAR) of about 21.7.
   17. The method according to any one of embodiments 1-16, wherein the alumina source is chosen from aluminum isopropoxide, aluminum sulfate, zeolites, aluminum oxides, aluminum hydroxides, kaolin clay, and combinations thereof.
   18. The method according to any one of embodiments 1-17, wherein the alumina source is aluminum isopropoxide.
   19. The method according to any one of embodiments 1-17, wherein the alumina source is aluminum sulfate.
   20. The method according to any one of embodiments 1-17, wherein the alumina source is zeolites such as Al-FAU, or Al-LTL.
   21. The method according to any one of embodiments 1-17, wherein the alumina source is an aluminum oxide.
   22. The method according to any one of embodiments 1-17, wherein the alumina source is an aluminum hydroxide.
   23. The method according to any one of embodiments 1-17, wherein the alumina source is kaolin clay.
   24. The method according to any one of embodiments 1-23, wherein the mineralizing agent is chosen from alkali hydroxides, fluorides, F⁻, quaternary ammonium hydroxide, diquaternary ammonium hydroxides, and combinations thereof.
   25. The method according to any one of embodiments 1-24, wherein the mineralizing agent is chosen from alkali hydroxides.
   26. The method according to any one of embodiments 1-24, wherein the mineralizing agent is chosen from fluorides.
   27. The method according to any one of embodiments 1-24, wherein the mineralizing agent is NaOH.
   28. The method according to any one of embodiments 1-24, wherein the mineralizing agent is KOH.
   29. The method according to any one of embodiments 1-24, wherein the mineralizing agent is F⁻.
   30. The method according to any one of embodiments 1-24, wherein the mineralizing agent is quaternary ammonium hydroxide.
   31. The method according to any one of embodiments 1-24, wherein the mineralizing agent is diquaternary ammonium hydroxide.
   32. The method according to any one of embodiments 1-31, wherein the OSDA is chosen from quaternary ammonium salts.
   33. The method according to embodiment 32, wherein the quaternary ammonium salts are chosen from trimethyl adamantyl ammonium hydroxide, trimethyl benzyl ammonium hydroxide, triethyl cyclohexyl ammonium hydroxide, and combinations thereof, preferably wherein the quaternary ammonium salts are chosen from trimethyl adamantyl ammonium hydroxide, trimethyl benzyl ammonium hydroxide, triethyl cyclohexyl ammonium hydroxide, and combinations thereof.
   34. The method according to embodiment 33, wherein the quaternary ammonium salt is trimethyl adamantyl ammonium hydroxide.
   35. The method according to embodiment 33, wherein the quaternary ammonium salt is trimethyl benzyl ammonium hydroxide.
   36. The method according to embodiment 33, wherein the quaternary ammonium salt is triethyl cyclohexyl ammonium hydroxide.
   37. The method according to any one of embodiments 1-36, wherein the silica source is chosen from colloidal silica, precipitated silica, fumed silica, sodium silicate, zeolitic silica, silica from kaolin clay, and combinations thereof.
   38. The method according to any one of embodiments 1-37, wherein the silica source is colloidal silica.
   39. The method according to any one of embodiments 1-37, wherein the silica source is precipitated silica.
   40. The method according to any one of embodiments 1-37, wherein the silica source is fumed silica.
   41. The method according to any one of embodiments 1-37, wherein the silica source is sodium silicate.
   42. The method according to any one of embodiments 1-37, wherein the silica source is zeolitic silica.
   43. The method according to any one of embodiments 1-37, wherein the silica source is silica from kaolin clay.
   44. The method according to any one of embodiments 1-43, wherein the silica source comprises a SiO₂/Na₂O wt % ratio of about 1.
   45. The method according to any one of embodiments 1-43, wherein the silica source comprises a SiO₂/Na₂O wt % ratio of about 2.
   46. The method according to any one of embodiments 1-43, wherein the sodium silicate comprises a SiO₂/Na₂O wt % ratio of about 3.
   47. The method according to any one of embodiments 1-43, wherein the sodium silicate comprises a SiO₂/Na₂O wt % ratio of about 3.3.
   48. The method according to any one of embodiments 1-43, wherein the sodium silicate comprises a SiO₂/Na₂O wt % ratio of about 4.
   49. The method according to any one of embodiments 1-48, wherein the silica source has a solids content of great than about 20 wt %.
   50. The method according to any one of embodiments 1-49, wherein the silica source has a solids content of great than about 30 wt %.
   51. The method according to any one of embodiments 1-50, wherein the silica source has a solids content of about 37 wt %.
   52. The method according to any one of embodiments 1-51, wherein the mole ratio of silica to alumina (SAR) in the gel is at least about 30.
   53. The method according to any one of embodiments 1-51, wherein the mole ratio of silica to alumina (SAR) in the gel is at least about 35.
   54. The method according to any one of embodiments 1-53, wherein the gel is heated at about 100 °C to about 200 °C.
   55. The method according to any one of embodiments 1-54, wherein the gel is heated from about 35 hours to about 38 hours.
   56. The method according to any one of embodiments 1-55, wherein the gel is heated for about 36 hours.
   57. The method according to any one of embodiments 1-56, wherein the intermediate phase is heated at about 100 °C to about 200 °C.
   58. The method according to any one of embodiments 1-57, wherein the intermediate phase is heated from about 35 hours to about 38 hours.
   59. The method according to any one of embodiments 1-58, wherein the intermediate phase is heated for about 36 hours.
   60. The method according to any one of embodiments 1-59, wherein the aqueous gel of step (a) further comprises a zeolite initiator.
   61. The method according to embodiment 60, wherein the zeolite initiator has a SiO₂/Al₂O₃ molar ratio of about 65.
   62. The method according to embodiment 60, wherein the zeolite initiator has a SiO₂/Na₂O molar ratio of about 1.7.
   63. The method according to embodiment 60, wherein the zeolite initiator has an H₂O/SiO₂ molar ratio of about 10.3.
   64. The method according to embodiment 60, wherein the zeolite initiator has a SiO₂/Al₂O₃ molar ratio of about 65, a SiO₂/Na₂O ratio of about 1.7, and an H₂O/SiO₂ molar ratio of about 10.3.
   65. The method according to any one of embodiments 1-64, wherein the SiO₂ yield of the zeolite is between about 50% and about 65%, based on complete aluminum conversion.
   66. The method according to any one of embodiments 1-64, wherein the SiO₂ yield of the zeolite is between about 55% and about 64%, based on complete aluminum conversion.
   67. The method according to any one of embodiments 1-66, comprising a sonic velocity profile wherein the ultrasonic measurement of the gel of step (a) is greater than about 1000 m/s.
   68. The method according to any one of embodiments 1-66, comprising a sonic velocity profile wherein the ultrasonic measurement of the intermediate phase of step (b) is about 5 m/s to about 15 m/s higher than that of the gel of step (a).
   69. The method according to any one of embodiments 1-66, comprising a sonic velocity profile wherein the ultrasonic measurement of the CHA zeolite of step (c) is about 7 m/s to about 17 m/s higher than that of the gel of step (a).
   70. The method according to any one of embodiments 1-66, comprising a sonic velocity profile wherein the ultrasonic measurement of the gel of step (a) is greater than about 1000 m/s; the ultrasonic measurement of the intermediate phase of step (b) is about 5 m/s to about 15 m/s higher than that of the gel of step (a); and the ultrasonic measurement of the CHA zeolite of step (c) is about 7 m/s to about 17 m/s higher than that of the gel of step (a).
   71. The method according to any one of embodiments 1-70, wherein the method further includes isolating the CHA zeolite by filtration.
   72. The method according to embodiment 71, wherein the isolated phase pure zeolite is dried and calcined to yield the Na⁺ form.
   73. The method according to embodiment 72, wherein the calcination takes place at greater than about 500 °C.
   74. The method according to embodiment 72 or 73, wherein the calcination takes place at a temperature between from about 500 °C to about 550 °C.
   75. The method according to any one of embodiments 72-74, wherein the calcination takes place for more than about 5 hours.
   76. The method according to any one of embodiments 72-75, wherein the calcination takes place for about 7 hours.
   77. The method according to any one of embodiments 72-76, wherein the calcined zeolite is subjected to an NH₄⁺ exchange to a NH₄⁺ form zeolite.
   78. The method according to embodiment 77, wherein the NH₄ form has a Na₂O content of less than about 500 ppm.
   79. The method according to any one of embodiments 77 or 78, wherein a zeolite catalyst is formed by introducing Cu ions to the NH₄ form CHA zeolite.
   80. The method according to embodiment 77 or 78, wherein the NH₄ form is calcined to produce an H⁺ form.
   81. The method according to embodiment 80, wherein the calcination takes place at greater than about 400 °C.
   82. The method according to embodiment 80 or 81, wherein the calcination takes place at a temperature ranging between about 400 °C and about 450 °C.
   83. The method according to any one of embodiments 80-82, wherein the calcination takes place at about 450 °C.
   84. The method according to any one of embodiments 80-83, wherein the calcination takes place for more than about 5 hours.
   85. The method according to any one of embodiments 80-84, wherein the calcination takes place for about 6 hours.
   86. The method according to any one of embodiments 80-85, wherein a zeolite catalyst is formed by introducing Cu ions to the H⁺ form CHA zeolite.
   87. The method according to embodiment 79 or 86, wherein the copper-exchanged CHA zeolite has a copper loading from about 3.0 wt % to about 6.0 wt. %.
   88. The method according to embodiment 79 or 86, wherein the copper-exchanged CHA zeolite has a copper loading of about 3.0 wt %.
   89. The method according to embodiment 79 or 86, wherein the copper-exchanged CHA zeolite has a copper loading of about 4.0 wt. %.
   90. The method according to embodiment 79 or 86, wherein the zeolite catalyst as a copper loading of about 4.8 wt. %.
   91. The method according to embodiment 79 or 86, wherein the copper-exchanged CHA zeolite has a copper loading of about 5.0 wt. %.
   92. The method according to embodiment 79 or 86, wherein the copper-exchanged CHA zeolite has a copper loading of about 6.0 wt. %.
   93. The method according to any one of embodiments 1-92, wherein the CHA zeolite has greater than about 75% CHA framework, preferably greater than about 80% CHA framework, preferably greater than about 85% CHA framework, more preferably greater than about 90% CHA framework, more preferably greater than about 95% CHA framework.
   94. The method according to any one of embodiments 1-93, wherein the CHA zeolite has less than about 25% MOR framework, preferably less than about 20% MOR framework, more preferably less than about 15% MOR framework, more preferably less than about 10% MOR framework, more preferably less than about 5% MOR framework.
   95. The method according to embodiments 1 to 94, comprising:
(a) preparing an aqueous mixture comprising a silica source, an alumina source, a mineralizing agent, a zeolite initiator, and an organic structure directing agent (OSDA) to form a gel;
wherein the silica source is chosen from colloidal silica, precipitated silica, fumed silica, sodium silicate, zeolitic silica, silica from kaolin clay, and combinations thereof, wherein the alumina source is chosen from zeolites selected from the group consisting of Al-FAU and Al-LTL;
wherein the mineralizing agent is chosen from alkali hydroxides, fluorides, F⁻, quaternary ammonium hydroxide, diquaternary ammonium hydroxides, and combinations thereof,
wherein the OSDA is chosen from quaternary ammonium salts;
wherein the zeolite initiator has one or more of a SiO₂/Al₂O₃ molar ratio of 65, a SiO₂/Na₂O molar ratio of 1.7, and an H₂O/SiO₂ molar ratio of 10.3;
(b) heating the gel at 100 °C to 200 °C to form an intermediate phase comprising mordenite (MOR) crystals; and
(c) further heating the intermediate phase at 100 °C to 200 °C to obtain a CHA zeolite having greater than about 75% CHA framework and less than 25% MOR framework.
   96. A copper-exchanged CHA zeolite, wherein the zeolite has a zeolite surface area (ZSA) greater than about 450 m²/g.
   97. A copper-exchanged CHA zeolite, obtained or obtainable by the method according to any one of claims 1-95.
   98. The copper-exchanged CHA zeolite of embodiment 96 or 97, wherein the zeolite has a silica to alumina ratio (SAR) from about 15 to about 22.
   99. The copper-exchanged CHA zeolite of embodiment 96 or 97, wherein the zeolite has an SAR of about 17.
   100. The copper-exchanged CHA zeolite of embodiment 96 or 97, wherein the zeolite has an SAR of about 21.
   101. A method of producing a catalytic article, the method comprising the steps of:
(a) coating a substrate with a catalytic coating via a washcoat process; and
(b) drying and calcining the coated substrate at greater than about 500 °C preferably for about 1 hour or more, more preferably for about 1 hour;
wherein the catalytic coating comprises the CHA zeolite of embodiment 1 with a CuO loading of from about 3.0 wt % to about 6.0 wt %, about 5% zirconium oxide and about 5% pseudoboehmite (PB-250) binder.
   102. The method of embodiment 101, wherein the coating step provides a catalyst loading of about 2.1 g/in³.
   103. The method of embodiment 102, wherein the catalyst loading further comprises about 5% to about 10% zirconium oxide and about 5% to about 10% aluminum oxide binder.
   104. The method of any one of embodiments 101-103, wherein the catalytic article has a cell density of about 400 cpsi.
   105. The method of any one of embodiments 101-104, wherein the catalytic article has a wall thickness of about 6 mm.
   106. A catalytic article comprising a copper-exchanged CHA zeolite produced according to the method of any one of embodiments 101-105, wherein the zeolite has a zeolite surface area (ZSA) greater than about 450 m²/g.
   107. A method of reducing nitrogen oxides (NOₓ), the method comprising contacting a gaseous stream containing nitrogen oxides with at least one copper exchanged CHA zeolite of any one of embodiments 97-100 or at least one catalytic article of embodiment 106 at a temperature ranging from about 200 °C to about 550 °C.
   108. The method according to embodiment 107, wherein the method comprises selectively reducing NOₓ using ammonia or an ammonia precursor.
   109. The method according to embodiment 108, wherein the selective reduction of NOₓ takes place at a temperature ranging from about 200 °C to about 550 °C.
   110. The method according to any one of embodiments 107-109, wherein the reduction of NOₓ at about 200 °C is greater than about 60%,
   111. The method according to any one of embodiments 105-107, wherein the reduction of NOₓ at about 200 °C is greater than about 63%.
   112. The method according to any one of embodiments 107-109, wherein the reduction of NOₓ at about 550 °C is greater than about 75%.
   113. The method according to any one of embodiments 107-112, wherein the reduction of NOₓ at about 200 °C is greater than about 65% and the reduction of NOₓ at about 550 °C is greater than about 75%.
   114. The method according to any one of embodiments 107-113, wherein the reduction of NOₓ is maintained after hydrothermal aging of the zeolite.
   115. The method according to embodiment 114, wherein the hydrothermal aging takes place in the presence of about 10% H₂O/air at about 800 °C for about 16 hours.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the claims.

1. A method of preparing a chabazite (CHA) zeolite comprising:
(a) preparing an aqueous mixture comprising a silica source, an alumina source, a mineralizing agent, and an organic structure directing agent (OSDA) to form a gel;
(b) heating the gel at about 100 °C to about 200 °C to form an intermediate phase comprising mordenite (MOR) crystals; and
(c) further heating the intermediate phase at about 100 °C to about 200 °C to obtain a CHA zeolite, wherein the CHA zeolite preferably has a substantially greater CHA framework.

2. (canceled)

3. The method according to claim 1 wherein step (b) is maintained for less than about 100 hours.

4. The method according to claim 1, wherein the SiO₂ yield of the zeolite is greater than about 50%, based on complete aluminum conversion.

5. The method according to claim 1, wherein the CHA zeolite has a silica to alumina ratio (SAR) of greater than about 15.

6. The method according to claim 1, wherein the alumina source is chosen from aluminum isopropoxide, aluminum sulfate, zeolites, aluminum oxides, aluminum hydroxides, kaolin clay, and combinations thereof.

7. The method according to claim 1, wherein the mineralizing agent is chosen from alkali hydroxides, fluorides, F⁻, quaternary ammonium hydroxide, diquaternary ammonium hydroxides, and combinations thereof.

8. The method according to claim 1, wherein the OSDA is chosen from quaternary ammonium salts.

9. The method according to claim 1, wherein the silica source is chosen from colloidal silica, precipitated silica, fumed silica, sodium silicate, zeolitic silica, silica from kaolin clay, and combinations thereof.

10. The method according to claim 1, wherein the silica source comprises a SiO₂/Na₂O wt % ratio from about 1 to about 4 and a solids content of greater than about 20 wt %.

11. The method according to claim 1, wherein the mole ratio of silica to alumina (SAR) in the gel is at least about 30.

12. The method according to claim 8, wherein the quaternary ammonium salts are chosen from trimethyl adamantyl ammonium salts, trimethyl benzyl ammonium salts, triethyl cyclohexyl ammonium salts, and combinations thereof.

13. (canceled)

14. The method according to claim 1, further comprising the steps of:
(d) performing an NH₄⁺ exchange to form a NH₄⁺ form zeolite;
(e) optionally calcining the NH₄⁺ zeolite to yield an H⁺ form zeolite; and
(f) introducing Cu ions to the H⁺ form or NH₄⁺ form zeolite to form a zeolite catalyst.

15. The method according to claim 1, wherein the aqueous gel of step (a) further comprises a zeolite initiator, wherein the zeolite initiator has one or more of a SiO₂/Al₂O₃ molar ratio of about 65, a SiO₂/Na₂O molar ratio of about 1.7, and an H₂O/SiO₂ molar ratio of about 10.3.

16. The method according to claim 1, comprising:
(a) preparing an aqueous mixture comprising a silica source, an alumina source, a mineralizing agent, a zeolite initiator, and an organic structure directing agent (OSDA) to form a gel;
wherein the silica source is chosen from colloidal silica, precipitated silica, fumed silica, sodium silicate, zeolitic silica, silica from kaolin clay, and combinations thereof;
wherein the alumina source is chosen from zeolites selected from the group consisting of Al-FAU and Al-LTL;
wherein the mineralizing agent is chosen from alkali hydroxides, fluorides, F⁻, quaternary ammonium hydroxide, diquaternary ammonium hydroxides, and combinations thereof, wherein the OSDA is chosen from quaternary ammonium salts;
wherein the zeolite initiator has one or more of a SiO₂/Al₂O₃ molar ratio of 65, a SiO₂/Na₂O molar ratio of 1.7, and an H₂O/SiO₂ molar ratio of 10.3;
(b) heating the gel at 100 °C to 200 °C to form an intermediate phase comprising mordenite (MOR) crystals; and
(c) further heating the intermediate phase at 100 °C to 200 °C to obtain a CHA zeolite having greater than about 75% CHA framework and less than 25% MOR framework.

17. A copper-exchanged CHA zeolite, wherein the zeolite has a zeolite surface area (ZSA) greater than about 450 m²/g.

18. A copper-exchanged CHA zeolite, obtained or obtainable by the method according to claim 1.

19. The copper-exchanged CHA zeolite according to claim 17, wherein the zeolite has a copper loading ranging from about 3.0 wt % to about 6.0 wt %.

20. A method of producing a catalytic article comprising:
(a) coating a substrate with a catalytic coating via a washcoat process; and
(b) drying and calcining the coated substrate at a temperature of greater than about 500 °C;
wherein the catalytic coating comprises the CHA zeolite of claim 1 with a copper loading ranging from about 3.0 wt % to about 6.0 wt %, about 5% zirconium oxide, and about 5% pseudoboehmite (PB-250) binder.

21. A catalytic article produced according to the method of claim 20, comprising a copper-exchanged CHA zeolite, wherein the zeolite has a zeolite surface area (ZSA) greater than about 450 m²/g.

22. A method of reducing nitrogen oxides (NOₓ) comprising contacting a gaseous stream containing nitrogen oxides with at least one copper-exchanged CHA zeolite, wherein the zeolite has a zeolite surface area (ZSA) greater than about 450 m²/g, or at least one catalytic article of claim 21.
